(19) United States
(12) Patent Application Publication
(10) Pub. No.: US 2022/0183213 A1
(43) Pub. Date: Jun. 16, 2022

(54) WATERSHED AND MULCH SLOT SYSTEM

(71) Applicant: Richard K. Houston, Kansas City, MO (US)

(72) Inventor: Richard K. Houston, Kansas City, MO (US)

(21) Appl. No.: 17/551,108

(22) Filed: Dec. 14, 2021

Related U.S. Application Data
(60) Provisional application No. 63/125,376, filed on Dec. 14, 2020.
(60) Provisional application No. 63/218,583, filed on Jul. 6, 2021.

(51) Int. Cl. A01B 79/00

(52) U.S. Cl. CPC A01B 79/00; A01C 21/00

(57) ABSTRACT

Methods of preparing soil for farming to enhance the capture and retention of moisture. Steps may include forming an elongated slot in the soil of an agricultural field between and substantially parallel to adjacent crop rows. The slot is filled with mulch so that a portion of the mulch extends above the surface of the soil proximate the slot. One or more layers of salt and biochar, or a premix of salt and biochar, are then applied to the soil surface between the crop row and the slot to encourage runoff of surface water into the mulch slot. A surfactant and cation exchange stimulant is applied to the mulch within the slot.

### CROSS REFERENCE TO RELATED APPLICATIONS

This application claims the benefit of prior-filed, co-pending provisional patent applications, Ser. No. 63/125,376, filed Dec. 14, 2020, and Ser. No. 63/218,583, filed Jul. 6, 2021.

### BACKGROUND OF THE INVENTION

### Field of the Invention

The present invention relates to systems and methods for preparing a field for crop growth and for maximizing subsoil water retention.

### Description of the Related Art

In general, methods of preparing a field to receive and grow agricultural crops are well known in the prior art. Prior art systems include the creation of a vertical slot between and parallel to adjacent crop rows to receive rainwater or irrigation water, and filling the slot with mulch to reinforce and maintain the structural integrity of the slot, absorb a portion of the water, and to mitigate evaporation. Even with such systems, however, a significant amount of water falling upon a field may evaporate before running into the slots, or, even if soaking into the upper surface of the soil, rapidly evaporate thereafter.

In certain drought-prone area of the world, such as West Africa, it is known that certain shrubs, namely Guiera senegalensis (Guiera), can increase the amount of water in adjacent soil by drawing water upward from much lower soil levels. Guiera roots can grow 30 or more feet beneath the ground surface to tap into moisture available even in desert climates. It has been determined that at night water drawn by a Guiera plant from these deep roots in excess to the plant's needs leaks out of the body of the plant through surface roots into surrounding soil versus through leaf transpiration. This increased moisture provided to soil near the surface has been successfully used as a form of bioirrigation by cultivating Guiera shrubs in close proximity to agricultural crop plants.

What is needed are systems and methods that provide for capturing and retaining moisture at soil depths typically occupied by crop plant roots, thereby providing enhanced water availability for crops in dry, desert or drought-prone areas and/or without increasing irrigation. As disclosed herein, such systems and methods include enhancing runoff into mulch slots in order to capture more rain or irrigation water in the slot to thereby disperse or leach the captured water to surrounding soil and crop root systems well below the soil surface. This methods may be augmented or enhanced by use of bioirrigation and windbreaks.

The teachings of Pat. No. 3,556,026 to Richard K. Houston, from application No. 859,621, are incorporated herein by reference.

### SUMMARY OF THE INVENTION

One or more embodiments of the present invention may comprise a system and method of agricultural field preparation including an elongated mulch slot cut or dug between adjacent crop rows and running substantially parallel thereto. The mulch slot is filled with any of various types of materials generally referred to as mulch. A layer of salt (eg. NaCl) is applied to the surface of the soil in between a crop row, which is elevated relative to the slot, and an adjacent slot, in order to enhance water runoff into the slot and lessen the amount of water soaking into the upper soil surface. The salt is typically pre-mixed with biochar prior to application in order to avoid overconcentration of salt in a given area and to allow both the salt and biochar to be applied in one operation. Biochar applied to a soil surface has been shown to increase the speed at which a crop grows due to enhanced heat retention. The black color of the biochar material tends to increase absorption of solar radiation.

While salt applied to a soil surface enhances water runoff into an adjacent slot, it also presents a problem, particularly over time, in that some small portion of salt will wash into the slot thereby creating a partial barrier that reduces water intake into the slot. This problem is mitigated in the present invention by the application of a surfactant and cation exchange stimulant, such as a product produced by the company 1st EnviroSafety, Inc. and marketed under the trademark BioWash™.

A method of preparing soil for farming, to enhance the capture and retention of moisture, and according to the present invention, may include the steps of forming an elongated slot in the soil of an agricultural field so that the slot extends longitudinally along the soil surface and substantially vertically downward from the soil surface. The slot is positioned or located to be spaced apart from, and substantially parallel to, a crop row. Often, a slot is positioned between two adjacent parallel crop rows. Subsequent to being formed, the slot is filled with mulch so that a portion of the mulch extends above the surface of the soil proximate the slot. One or more layers of salt and biochar are then applied to the soil surface between the crop row and the slot. In certain embodiments, biochar is applied along the surface of a crop row. A surfactant and cation exchange stimulant is applied to the mulch within the slot.

In certain embodiments of the invention, the mulch comprises crop residue. In certain embodiments, the slot is formed to a dimension of approximately 2 to 6 inches wide by approximately 5 to 10 inches deep; in other embodiments, the slot is formed to a dimension of approximately 4 inches wide by approximately 8 inches deep. In certain embodiments, the biochar comprises a mixture of crop residue and livestock manure previously subjected to pyrolysis. The biochar and salt are applied separately to the soil surface between the crop row and the slot in some embodiments of the method of the present invention, in other embodiments the biochar and salt are premixed prior to application.

In certain embodiments of the present invention, the method may include the step of cutting a hardpan slot downward into the surface of the soil proximate a crop row so that the hardpan slot extends into the soil a sufficient depth to penetrate a soil hardpan layer.

The crop or crops planted within the crop row may include grains, legumes, root vegetables, trees and livestock feed. In some embodiments, a field prepared in accordance with the present invention is irrigated using aerated or structured water, and in some embodiments the field is irrigated using water amended by the addition of urea. In certain embodiments of the present invention, the method may comprise the step of planting one or more bioirrigation plants proximate a crop row. Bioirrigation plants may comprise shrubs in the Guiera senegalensis species. In certain embodiments, the method may comprise the step or steps of planting one or more rows of trees spaced apart from and parallel to a crop row to serve as a windbreak. Trees may include mesquite, poplar and poplar hybrids.

Other advantages of the invention will become apparent from the following description taken in connection with the accompanying drawings, wherein is set forth by way of illustration and example several embodiments of the present invention.

### BRIEF DESCRIPTION OF THE DRAWINGS

FIG. 1 is a diagram showing a fragmentary, vertical, cross-sectional view of a portion of a field prepared according to the prior art.

FIG. 2 is a diagram showing a fragmentary, vertical, cross-sectional view of a portion of a field prepared according to the present invention.

FIG. 3 is a diagram showing a top, perspective view of a portion of a field prepared according to the present invention.

### DETAILED DESCRIPTION

As required, a detailed embodiment of the present invention is disclosed herein; however, it is to be understood that the disclosed embodiment is merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

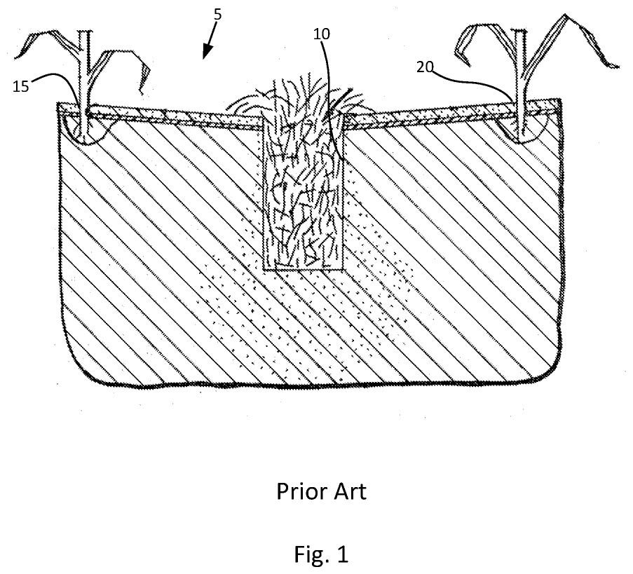

Referring now to the drawings, FIGS. 1 illustrates, in cross-sectional view, a portion of a field 5 prepared according to the prior art including a mulch slot 10 interposed between crop rows 15 and 20, with surface drainage sloping from the crop rows 15 and 20 to the mulch slot 10.

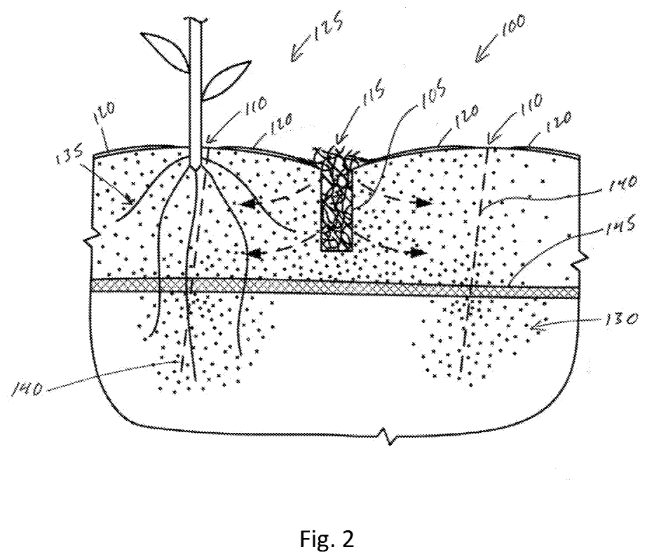

FIG. 2 is a diagram showing a fragmentary, vertical cross-sectional view of a portion of field prepared according to the present invention (i.e. a “prepared field 100”). As in the prior art, a mulch slot 105 is prepared to run parallel to, and interposed between, crop rows 110, with surface drainage sloping from the crop rows 110 to the mulch slot 105. The mulch slot 105 is filled with any of various types of materials generally referred to as mulch 115, which may include crop waste or residue (hereinafter referred to collectively as crop residue). As shown, the field preparation is improved by addition of a layer of biochar material mixed with salt between each mulch slot 105 and adjoining crop row 110. It should be noted that the figures are diagrammatic and not to scale, certain elements being enlarged, for example, for clarity.

In certain embodiments of a field prepared according to the present invention, each crop row 110 is approximately 4 inches wide, each biochar/salt strip 120 is also approximately 4 inches wide, and each mulch slot 105 is approximately 4 inches wide and approximately 4 to 10 inches deep. In some embodiments, the mulch slot 105 is approximately 7 to 10 inches deep. Note that these dimensions may be altered to adjust for crop size or other variables with optimal dimensions being determined by experimentation. For example, for a crop comprising wheat the crop row 110 and biochar/salt strip 120 widths may be adjusted from approximately 4 inches to 3 inches. In certain embodiments of the invention, a field may be prepared so that a pair of crop rows 110 with mulch slot 105 therebetween (i.e., a crop row set 125) is prepared approximately every 10 feet so that tractors and other machines may pass between crop row sets 125.

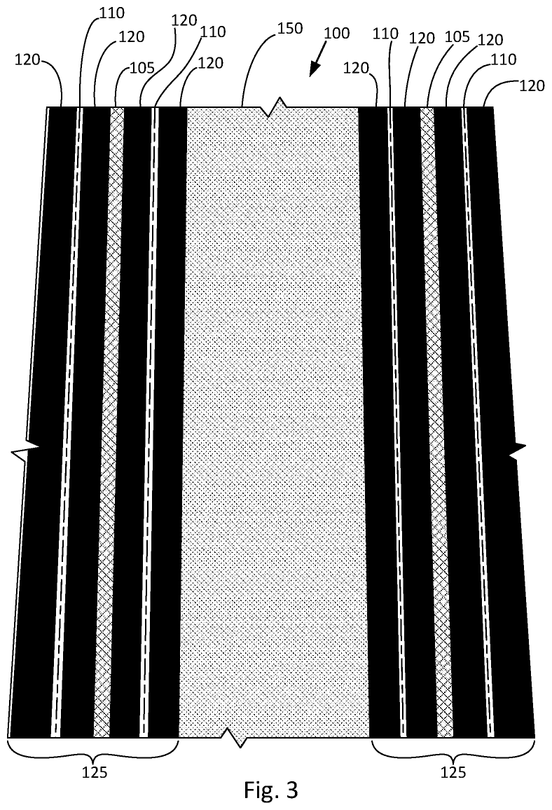

FIG. 3 is a diagram showing a perspective view of a portion of a prepared field 100 with an elongated mulch slots 105 indicated in cross hatch shading, planting or crop rows 110 indicated in broken lines, and biochar/salt strips 120 applied to portions of the field 100 on either side of each crop row 110 and between each crop row 110 and mulch slot 105.

Biochar may be prepared in accordance with certain embodiments of the present invention by recycling plant material grown in a prepared field. For example, after grain is harvested from wheat grown in a prepared field 100, the straw may be gathered to use as animal bedding, such as bedding used in a feedlot for animals such as beef cattle. Periodically, used bedding is removed along with manure deposited by the animals on and in the bedding and burned under conditions known in the prior art to form a biochar material. This biochar may then be mixed with salt for application to a field to form the previously described biochar/salt strips 120. In certain embodiments of the invention, biochar without salt is applied to the crop rows (not shown) and biochar mixed with salt is applied to either side of each crop row 110 as previously described.

In certain embodiments of the invention, a field may be prepared for growing trees. In certain further embodiments, a field may be prepared for growing trees in discrete, parallel planting strips (tree rows), as well as other crops planted in between said tree rows. Optimal field, tree row and crop row 110 dimensions for particular trees and crops may be determined with minimal research and experimentation. An operable set of dimensions may comprise trees planted in tree row sets wherein tree rows are spaced parallel to one another and approximately 10 feet apart, and wherein tree rows are spaced approximately 200 feet apart, thereby providing space for crop row sets of wheat, corn or other crops. Fields prepared according to these embodiments to include trees will provide a natural windbreak via the trees thereby protecting crops grown in between tree rows. A windbreak will tend to reduce soil desiccation and crop damage. Biochar may be generated using both crop residue left in the field after harvest and any waste material obtained from the trees. Tree types or species that may be planted to form windbreaks include mesquite and poplar, including hybrid poplars. When eventually harvested, the trees may be ground or chipped to provide biomass for biomass gasification. Wood gas produced in this manner may reduce fossil fuel consumption and energy costs, while lowering the production of greenhouse gasses.

Salt applied in the biochar/salt strips 120, which slope downward from the crop rows 110, which are elevated relative to the mulch slots 105, increases the volume of water falling upon the surface of the biochar/salt strip 120 that runs into the mulch slot 105 versus soaking into the top layer of the soil in a prepared field 100. Salt used in the present invention typically comprises sodium chloride (NaCl), and in certain embodiments is applied to a soil surface at a selected rate between 100 to 800 pounds per acre. Runoff from a strip 120 into a proximate mulch slot 105 typically increases with the amount of salt applied. An optimal rate of application for a given field and soil type may be determined by minimal experimentation.

As generally indicated in FIG. 2 by dots 130 representing moisture content, location and dispersal in the soil, water that runs in to the mulch slot 105 will then disperse into the soil on either side of the mulch slot 105, as well as through the bottom of the mulch slot 105, thereby reducing the amount of water soaking into the upper soil surface and increasing the moisture content of the soil proximate crop roots 135 and well below the surface of the field. It is advantageous to lessen the amount of water from rain or irrigation soaking into the upper soil surface of the soil of a prepared field 100 because it is then more likely to evaporate before ever reaching the plant roots 135.

While salt applied to a soil surface enhances water runoff from said surface, it also presents a problem in that some small portions of salt will wash into the mulch slot 105 over time thereby potentially creating a partial barrier at the top of the mulch slot 105 that reduces water intake into the slot 105. Salt washing further into the slot 105 may also reduce the ability of water to disperse from within the slot 105 through the slot walls and floor to the soil. This problem is mitigated in the present invention by the application of a salt mitigation material, such as a surfactant and cation exchange stimulant, for example, the product marketed under the trademark BioWash™, within the mulch slot 105. The BioWash™ product comprises colloidal micelles that carry a negative charge and that attract cations (positive charged molecules). These cations include certain fertilizers and micronutrients. This salt mitigation material enhances the ability of water, and nutrients, to flow from within the mulch slot 105 to the surrounding soil and may neutralize various toxins. An operative salt mitigation material in the present invention comprises chelating agents, lipids and surfactants and may comprise certain of the following constituents:

Alcohols, Amino alcohols, Alkyl-oligo-glucopryanosides, Alkyl-polyglycoside, Alkanolamines, Almond oil, Aminopolycarboxylic acids, Cedar oil, Cinnamon oil, Citronella oil, Corn oil, Ethylenediamine-N,N′-disuccinic acid (EDDS), Ethylenediaminetetraacetic acid (EDTA), Disodium EDTA, Garlic extracts, Geranium oil, Jojoba oil, Karanj a oil, Lemongrass oil, Lilly extract, Mint oil, Peppermint oil, Neem oil, Soybean oil, Sodium Coco Poly Glucoside citrate, Ethyl Lactate, Dextronic acid, Gluconic Acid, Processed extracts of sugar cane, Tall Oil Fatty Acids, and Water.

In certain further embodiments of the invention, irrigation water is aerated prior to or while applied to a prepared field 100. Aeration of irrigation water increases the dissolved gases, including oxygen and carbon dioxide, which is beneficial both to irrigated crops and to soil microorganisms. In addition, aerated water includes entrained air bubbles which lessens the disruption of soil particles impacted by a stream or droplets of aerated water, thereby reducing soil movement and erosion. Irrigation water can be further amended by addition of urea later in the growing season to provide crops with additional nitrogen, since any nitrogen applied via fertilizer at the beginning of the season would likely be partially or substantially depleted.

Irrigation water used in certain embodiments of the present invention may comprise structured water. Structured water may be created by vortexing or through application of electrical current and has been demonstrated to enhance plant growth by means including increased uptake of minerals and other nutrients by the plant.

In yet further embodiments of the invention, a prepared field 100 includes a hardpan slot 140 cut generally vertically downward into the soil along a crop row 110. The hardpan slot 140 is cut into the soil a sufficient depth to penetrate into and through the horizontal hardpan layer 145 that typically forms approximately 10 to 14 inches below the soil surface. A depth of approximately 1 to 1.5 feet is typically a sufficient depth to penetrate the hardpan layer 145, but this should be first determined through observation and assessment for a given field. As indicated in FIG. 2, the hardpan slot 140 is substantially two dimensional and does include any open area as does the mulch slot 105. By penetrating the hardpan layer 145, the hardpan slot 140 provides a more ready conduit for water dispersing from the mulch slot 105 to penetrate through to the soil underlying the hardpan layer 145, thereby increasing the moisture content of this underlying soil and making it more available for plant roots 135.

In certain further embodiments of the invention, crops are planted in close proximity to bioirrigation plants, such as the Guiera shrub (e.g., Guiera senegalensis). Guiera shrubs are cultivated adjacent to crop rows in order to allow crops to utilize soil moisture drawn upward and delivered by the shrubs from soil depths well below that of crop root depths. Operable spacing between shrubs and crop plants for a given climate, soil type and crop type may be determined by experimentation. Use of bioirrigation by employing Guiera shrubs has been shown to allow an increase in crop density, crop yields, improved soil quality, increased nutrient dispersal, and a reduction in time from crop planting to harvest.

It is to be understood that while certain forms of this invention have been illustrated and described, it is not limited thereto except insofar as such limitations are included in the following claims and allowable equivalents thereof.

Having thus described the invention, what is claimed as new and desired to be secured by Letters Patent is:

1. A method of preparing soil for farming to enhance the capture and retention of moisture, the method comprising the steps of:
forming an elongated slot in the soil of an agricultural field, said slot extending longitudinally along the soil surface and substantially vertically downward from the soil surface, said slot positioned spaced apart from and substantially parallel to a crop row;
filling said slot with mulch so that a portion of said mulch extends above the soil surface proximate to said slot;
applying a layer of biochar to the soil surface between said crop row and said slot;
applying a layer of salt to said soil surface between said crop row and said slot; and
applying a surfactant and cation exchange stimulant to said mulch within said slot.

2. The method of claim 1 wherein said mulch comprises crop residue.

3. The method of claim 1 wherein said slot is formed to a dimension of approximately 2 to 6 inches wide by approximately 5 to 10 inches deep.

4. The method of claim 1 wherein said slot is formed to a dimension of approximately 4 inches wide by approximately 8 inches deep.

5. The method of claim 1 wherein said biochar comprises a mixture of crop residue and livestock manure subjected to pyrolysis.

6. The method of claim 1 wherein biochar is applied along the surface of said crop row.

7. The method of claim 1 wherein biochar and salt are applied separately to the soil surface between said crop row and said slot.

8. The method of claim 1 wherein said slot is positioned between two adjacent parallel crop rows.

9. The method of claim 1 wherein the crop planted within the crop row is selected from a group comprising grains, legumes, root vegetables, trees and livestock feed.

10. The method of claim 1 further comprising the step of irrigating said agricultural field using aerated or structured water.

11. The method of claim 10 further comprising the step of irrigating said agricultural field using water amended with the addition of urea.

12. The method of claim 1 further comprising the step of planting one or more bioirrigation plants proximate to said crop row.

13. The method of claim 12 wherein said bioirrigation plants comprise shrubs in the Guiera senegalensis species.

14. The method of claim 1 further comprising the step of planting a row of trees spaced apart from and parallel to said crop row to serve as a windbreak.

15. The method of claim 14 wherein said trees are selected from a group comprising mesquite, poplar and poplar hybrids.

16. A method of preparing soil for farming to enhance the capture and retention of moisture, the method comprising the steps of:
forming an elongated slot in the soil of an agricultural field between and substantially parallel to two adjacent crop rows, said slot extending longitudinally along the soil surface and vertically downward from the soil surface, the surface of the soil sloping downward in elevation from each of said crop rows to said slot;
substantially filling said slot with mulch;
applying a salt barrier to the soil surface between each of said crop rows and said slot; and
applying a salt mitigation material to said mulch.

17. The method of claim 16 wherein said salt barrier comprises a layer of salt premixed with biochar.

18. The method of claim 16 wherein said salt mitigation material comprises a surfactant and cation exchange stimulant.

19. The method of claim 16 further comprising the step of cutting a hardpan slot downward into the surface of the soil proximate said crop row and extending into the soil a sufficient depth to penetrate a soil hardpan layer.

20. A method of preparing an agricultural field to increase soil moisture uptake and content, and to enhance crop growth, said method comprising the steps of:
a. forming a plurality of vertically and longitudinally extending mulch slots in the surface of agricultural field soil, the mulch slots being spaced apart laterally from one another and from crop rows;
b. placing mulch material in the mulch slots;
c. applying a surfactant and cation exchange stimulant to the mulch material;
d. cutting a hardpan slot generally vertically downward into the soil along a crop row to a depth sufficient to penetrate the soil hardpan layer;
e. constructing moisture retarding barriers extending laterally from each mulch slot to convey water from the surface of a barrier into an adjacent mulch slot, the barriers comprising biochar material pre-mixed with a salt; and
f. planting a row of trees laterally spaced apart from, but substantially parallel to, a set of one or more mulch slots in order to form a windbreak.
